(19) United States
(12) Patent Application Publication
(10) Pub. No.: US 2019/0291826 A1
(43) Pub. Date: Sep. 26, 2019

(54) A CONNECTION DEVICE FOR ESTABLISHING A CONNECTION BETWEEN A VEHICLE AND A FLUID OR ENERGY DISTRIBUTION SYSTEM

(71) Applicant: IPALCO BV, Woerden (NL)

(72) Inventors: Michael WIDEGREN, Lugano (CH); Magnus EDELBERG, FURULUND (SE); David BLIXT, TRELLEBORG (SE)

(21) Appl. No.: 16/348,753

(22) PCT Filed: Oct. 20, 2017
(86) PCT No.: PCT/EP2017/076813

§ 371 Date: May 9, 2019

(30) Foreign Application Priority Data
Nov. 9, 2016 (LU) 93297

(51) Int. Cl. B63B 27/24; B67D 9/02

(52) U.S. Cl. CPC B63B 27/24; B63B 2021/002; B67D 9/02

(57) ABSTRACT

A connection device for establishing a connection between a vehicle (12) and a fluid or energy distribution system (14) comprises: a main support structure (16); a connector head (18), for releasably connecting to a connection facility (20) on the vehicle; a support beam (22) having a longitudinal axis (24), a front-end supporting the connector head (18) and a rear end; and a support mechanism (26). This support mechanism (26) supports the rear end of the support beam (22) in the main support structure (16), so that the support beam (22) is movable along its longitudinal axis (24) and has two translational degrees of freedom that are perpendicular to its longitudinal axis (24). An articulation (52) with three rotational degrees of freedom is connected between the front-end of the support beam (22) and the connector head (18).

### TECHNICAL FIELD

The present invention generally relates to a connection device for establishing a connection between a vehicle and a fluid or energy distribution system. It further relates to a connection system comprising such a connection device.

### BACKGROUND ART

Within the context of the present description, a vehicle is a mobile device that is used for carrying or transporting persons, goods and/or equipment on land, in the water or in the air. Typical vehicles are e.g. land vehicles (as for example: cars, trucks, busses, movable working machines, . . . ), rail-guided vehicles (as for example: trains, trams, cranes, . . . ), watercraft vehicles (as for example: ships, boats, ferries, submarines, . . . ), aircraft vehicles (as for example: planes).

WO 2004/099061 discloses a hydrocarbon transfer system comprising an articulated arm mechanism carrying a releasable connector for connecting to a floating structure. A substantially vertical first arm whose rear end is connected via a pair of first articulations to a support structure. A substantially horizontal second arm is connected with its rear end via a pair of second articulations to the front end of the first arm. Each of the first and second articulations provides three rotational degrees of freedom, identified as pitch, roll and yaw. The front end of the second arm carries via an articulation with three rotational degrees of freedom the releasable connector. Counterweights and damping means are provided to be able to easier control the pivoting movement (pitch) of the second arm about a horizontal axis defined by the pair of second articulations connecting the first arm to the second arm.

It is an object of the present invention to provide a connection device for establishing a connection between a vehicle and a fluid or energy distribution system, wherein this device shall have a compact, rugged and cost-efficient design, shall be easy to control during the connection operation and/or shall ensure a reliable connection, even in case of large misalignments, and/or shall tolerate small movements of the vehicle while connected to the connection device.

It is a further objective of the present invention to provide a connection device that is best suited for establishing a connection between a watercraft vehicle and a fluid or energy distribution system.

### SUMMARY OF INVENTION

In accordance with the present invention, a connection device for establishing a connection between a vehicle and a fluid or energy distribution system comprises: a main support structure, a connector head, for releasably connecting to a connection facility on the vehicle; a support beam having a longitudinal axis, a front-end supporting the connector head and a rear end; a support mechanism supporting the rear end in the main support structure, so that the support beam is movable along its longitudinal axis and has two translational degrees of freedom that are perpendicular to its longitudinal axis; and an articulation with three rotational degrees of freedom connected between the front-end of the support beam and the connector head. It will be appreciated that connection device may have a compact, rugged and cost efficient design, and nevertheless ensure a reliable connection, even in case of large misalignments, and tolerate small movements of the vehicle while connected to the connection device. Last but not least, in comparison to the hydrocarbon transfer system disclosed in WO 2004/099061, the proposed connection device greatly simplifies control of the trajectory of the coupling head during a connection operation.

A particularly compact, rugged and cost efficient embodiment of the support mechanism, which supports the support beam in the main support structure, comprises a three-dimensional parallelogram mechanism having a fixed rear end link supported by the main support structure and a movable front-end link supporting the support beam, whereby the support beam remains parallel to itself when the front-end link is moved out of a home position, either upward and downward or to the left and to the right. This home position is advantageously defined by springs and by gravity forces.

In the preferred embodiment, the front-end link of the three-dimensional parallelogram mechanism supports an elongate guide structure in a cantilevered way, wherein the rear end of the support beam is guided by this elongate guide structure so that the support beam is movable in a guided way along its longitudinal axis. This elongate guide structure is advantageously conceived as a kind of guide channel, in which the rear end of the support beam is slidingly received. To achieve a smooth guided movement, the rear end of the support beam advantageously includes wheels that are guided in rails of the elongate guide structure. Usually, the device further comprises a reversible drive for driving the support beam in a forward movement and a backward movement along the elongate guide structure. Such a drive is advantageously a linear drive, preferably a chain drive, more preferably an endless chain drive with a servo or stepper motor.

The articulation connected between the front-end of the support beam and the connector head is advantageously a cardan joint with three rotational degrees of freedom. The axes of rotation of two of these rotational degrees of freedom are preferably perpendicular to the longitudinal axis of the support beam, wherein the axis of rotation of the third rotational degree of freedom is parallel to the longitudinal axis of the support beam.

A preferred embodiment of such a cardan joint includes: an inner ring with two inner ring pivots, which are spaced by 180°, and two inner ring slotted holes, which are circumferentially extending and located at 90° from the two inner ring pivots; an outer ring with two outer ring pivots, which are spaced by 180°, and two outer ring slotted holes, which are circumferentially extending and located at 90° from the two outer ring pivots. The outer ring is mounted about the inner ring so that both rings are coaxial with a common central axis and can rotate relative to one another about this common central axis. The inner ring pivots are circumferentially guided in the outer ring slotted holes, and the outer ring pivots are circumferentially guided in the inner ring slotted holes. Thus, the outer ring and the inner ring cooperate to provide a first rotational degree of freedom. The outer ring pivots and inner ring pivots cooperate with the front-end of the support beam and the connector head, to define two further rotational degrees of freedom. It will be appreciated that this is a particularly compact, rugged and cost efficient embodiment of the articulation connected between the front-end of the support beam and the connector head.

Each of the three rotational degrees of freedom of the articulation connected between the front-end of the support beam and the connector head is preferably mechanically limited to less than +/−10°, preferably to less than +/−6°, most preferably in the range of +/−3° to +/−6°. Such rotational degrees of freedom are generally sufficiently important to ensure that the orientation of the connector head can compensate angular misalignments during the connection operation, and tolerate angular movements of the vehicle (rolling, pitching and yawing), while the connection device is connected to the connection facility of the vehicle. They are also sufficiently small to avoid a blocking of the connector head during the connection operation. If bigger rotational degrees of freedom are required, it is recommended to provide a spring centred home position for the connector head.

It will be appreciated that the proposed device is particularly interesting, if the vehicle to which a connection is to be established is a ship. This is, amongst others, due to the fact that the device tolerates without problem small translation and angular movements of the ship to which it is connected.

If the vehicle to which a connection is to be established is a ship, the proposed device advantageously further comprises a floating body supporting the main support structure.

In a preferred embodiment, the connector head comprises: a front side; a connector or a connector arrangement arranged on the front side; and at least four guide rolls or four guide roll arrangements arranged symmetrically around the connector or connector arrangement and/or two guide pins or two guide tubes or a guide pin and a guide tube arranged around the connector or the connector arrangement.

A connection system for establishing a connection between a vehicle and a fluid or energy distribution system comprises: a connection device as specified above; and a funnel-shaped connection facility on the vehicle. For establishing a connection between the vehicle and the fluid or energy distribution system, the connection head is introduced into the funnel-shaped connection facility.

In a preferred embodiment of this connection system, the funnel-shaped connection facility has an inlet section that has the shape of a truncated pyramid with four surfaces, each of these surfaces being capable of cooperating with one of the four guide rolls or one of the four guide roll arrangements on the connection head for centring the connection head in the funnel-shaped connection facility.

In a further preferred embodiment of this connection system, the funnel-shaped connection facility has at least one guide pin that cooperates with a guide tube on the connector head and/or at least one guide tube that cooperates with a guide pin on the connector head.

### BRIEF DESCRIPTION OF DRAWINGS

The afore-described and other features, aspects and advantages of the invention will be better understood with regard to the following description of preferred embodiments of the invention and upon reference to the attached drawings, wherein:

FIG. 1: is a schematic elevation view illustrating a device for establishing a connection between a vehicle and a fluid or energy distribution system;

FIG. 2: is schematic a top view illustrating the device of FIG. 1;

FIG. 3: is a three-dimensional view showing a preferred embodiment of a connector head;

FIG. 4: is a three-dimensional view showing a preferred embodiment of a connecting facility on the vehicle, designed for cooperating with the connector head of FIG. 3;

FIG. 5: is a three-dimensional view of an articulation with three rotational degrees of freedom supporting the connector head; and

FIG. 6: is a side view showing, in a very diagrammatic representation, the device of FIG. 1 connected to a ship.

### DETAILED DESCRIPTION OF PREFERRED EMBODIMENTS OF THE INVENTION

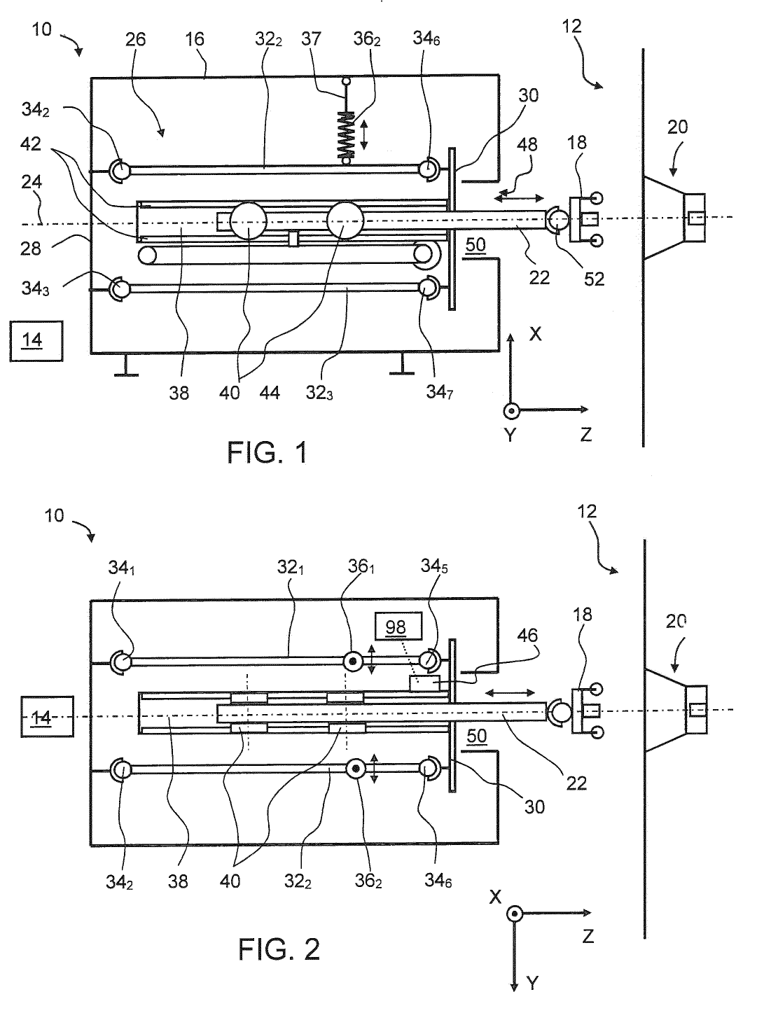

FIGS. 1 & 2 show a connection device, globally identified with reference number 10, which is drawn in a diagrammatic manner to better illustrate different mechanical concepts implemented in this device. Such a device 10 is used for establishing a connection between a vehicle represented by a section through its outer wall 12 (in the following, reference number 12 will also be used to identify the vehicle as such), and an electric energy or fluid distribution system, schematically represented by rectangle 14.

While this device 10 has been especially developed for connecting an electrically powered ferry to an electric power distribution system, for recharging the batteries of the ferry, the vehicle 12 may also be: a land vehicle (as for example: a car, a truck, a bus, a movable working machine, . . . ); a railed vehicle (as for example: a train, a tram, a crane, . . . ); a watercraft vehicle (as for example: a ships, a boat, a submarine, . . . ); or an aircraft vehicle (as for example: a plane).

The distribution system 14, to which this vehicle is to be connected, may also be a distribution system for: a liquid (as for example: water, liquid fuel, hydraulic oil, or any liquid transported by the vehicle); a gas (as for example: pressurized air, gaseous fuel, or any gas transported by the vehicle); or even a pneumatically or hydraulically conveyable solid/fluid or solid/gas mixture.

The connection device 10 comprises an outer casing and main support structure 16, which advantageously comprises a closed casing protecting the mechanisms inside against harsh environments. In FIG. 1, a side wall of this closed casing 16 is shown as a transparent wall, so that one may see inside the casing; in FIG. 2 this is also the case for a top wall of the casing. Reference number 18 globally identifies a connector head, for releasably connecting to a connection facility 20 in the vehicle wall 12. This connector head 18 is supported at the front end of a support beam 22, which has a longitudinal axis 24. The rear end of the support beam 22 is supported in the main support structure 16 by means of a mechanism 26 that provides to the support beam 22 two translational degrees of freedom X, Y that are perpendicular to its longitudinal axis 24. (In the coordinate system X, Y, Z shown in FIGS. 1 and 2, reference axis X is supposed to be vertical, gravity forces acting in the opposite direction of reference axis X.)

In a preferred embodiment, the mechanism 26 comprises a three-dimensional parallelogram mechanism. This mechanism has a fixed rear end link or frame link 28, which is formed by (respectively supported by) the main support structure 16, and a movable front-end link formed by a front plate 30. Four parallel connection links 32ᵢ (i=1 to 4), which all have the same length, connect the movable front plate 30 to the rear end link 28, wherein eight cardan joints 34ᵢ (i=1 to 8), each of them having two rotational degrees of freedom, form the four joints between the parallel connection links 32ᵢ and the front plate 30, respectively the four joints between the parallel connection links 32ᵢ and the rear end link 28. The front plate 30 can consequently be moved vertically up and down (i.e. parallel to reference axis X) and sideways to the left and to the right (i.e. parallel to reference axis Y), wherein the three-dimensional parallelogram mechanism 26 ensures that the movable front plate 30 remains always parallel to itself.

Two suspension springs 36₁, 36₂ are connected between the upper connection links 32_{1,2} and the outer casing 16, so as to resiliently oppose a downward and sideward movement of the front plate 30. In a section that is perpendicular to the plane of FIG. 1, one would see that the central axis of both springs 36₁, 36₂ are not entirely vertical, but that they are slightly inclined to one another, with the apex of intersection of these axes located below the parallelogram mechanism 26. Gravity forces urge the front plate 30 downwards in the opposite direction of reference axis X. The front plate 30 has a central home position in which the suspension springs 36₁, 36₂ compensate gravity forces. When the front plate 30 is moved above this central home position, the suspension springs 36₁, 36₂ are bypassed (i.e. they no longer axially engage a supporting rod 37), so that gravity forces are solely responsible for urging it back into the central home position. When the front plate 30 is moved below its central home position, the two suspension springs 36₁, 36₂ urge it back into the central home position. It will be appreciated that this is a very efficient, inexpensive and rugged design for ensuring a spring centred home position, but that it is of course also possible to use more than two springs for achieving a similar result. Instead of being connected to the upper connection links 32_{1,2}, the springs 36₁, 36₂ can also be connected to the lower connection links 32₃, 36₄ or to the front plate 30. Instead of using extension springs as shown in the drawings (which extension springs are extended by forces acting on the three-dimensional parallelogram mechanism 26), one can also use compression springs (which compression springs are compressed by forces acting on the three-dimensional parallelogram mechanism 26) or torsion springs associated with one or more of the cardan joints 34ᵢ (which torsion springs are twisted by the torque produced by forces acting on the three-dimensional parallelogram mechanism 26).

The front plate 30 supports an elongate guide structure 38 in a cantilevered manner in the space between the four parallel connection links 32ᵢ. The three-dimensional parallelogram mechanism 26 consequently ensures that the elongate guide structure 38 can be moved vertically up and down (i.e. a movement parallel to reference axis X) and sideways to the left and to the right (i.e. a movement parallel to reference axis Y), while always remaining parallel to itself (i.e. parallel to the reference axis Z). In the elongate guide structure 38, the rear end of the support beam 22 is guided so as to be solely movable in a translation movement along its longitudinal axis 24, i.e. parallel to the reference axis Z. In a preferred embodiment, the elongate guide structure 38 has the form of a guide channel 38 in which the rear end of the support beam 22 is slidingly received. To achieve a smooth linear guidance of the support beam 22 along its longitudinal axis 24, the rear end of the support beam 22 is preferably equipped with two pairs of wheels 40 guided in two pairs of rails 42, but other kinds of guidance systems, with or without wheels and/or rails, are not excluded. To move the support beam 22 along its longitudinal axis 24 forward and backward parallel to the reference axis Z, the support beam 22 is connected to a reversible linear drive 44, preferably an endless chain drive equipped with a reversible motor 46, preferably a servo motor or a stepper motor. Alternatively, a reversible motor may also be mounted on the support beam 22 and be equipped with a toothed wheel engaging with a toothed rail or with a chain, which are fixed on the guide channel 38. As a further alternative, a linear motor may be used for driving support beam 22.

The front plate 30 is arranged behind a front opening 48 in the outer casing 16. Through this front opening 48, the support beam 22 can push the connector head 18 out of the casing 16, in the direction of reference axis Z, or retract it back into a frontal cavity 50 of the outer casing 16. When the device 10 is not used, the support beam 22 is entirely retracted, wherein the connector head 18 is located in the frontal cavity 50, which is then advantageously closed by means of e.g. a sliding door, a hatch or a rolling shutter (not shown). In FIGS. 1 & 2, the support beam 22, is shown moved forward by about half of the maximum possible stroke and in a central position of the front opening 48, which corresponds to the above-described central home position the of the front plate 30.

Still referring to FIGS. 1 & 2, reference number 52 identifies an articulation with three rotational degrees of freedom connected between the front end of the support beam 22 and the connector head 18. Each of these three rotational degrees of freedom of the articulation 52 is preferably mechanically limited to less than +/−10°, preferably to less than +/−6°, more preferably to the range of +/−3° to +/−6°. Any or all of the three rotational degrees of freedom of the articulation 52 may have but need not have a spring-centred home position.

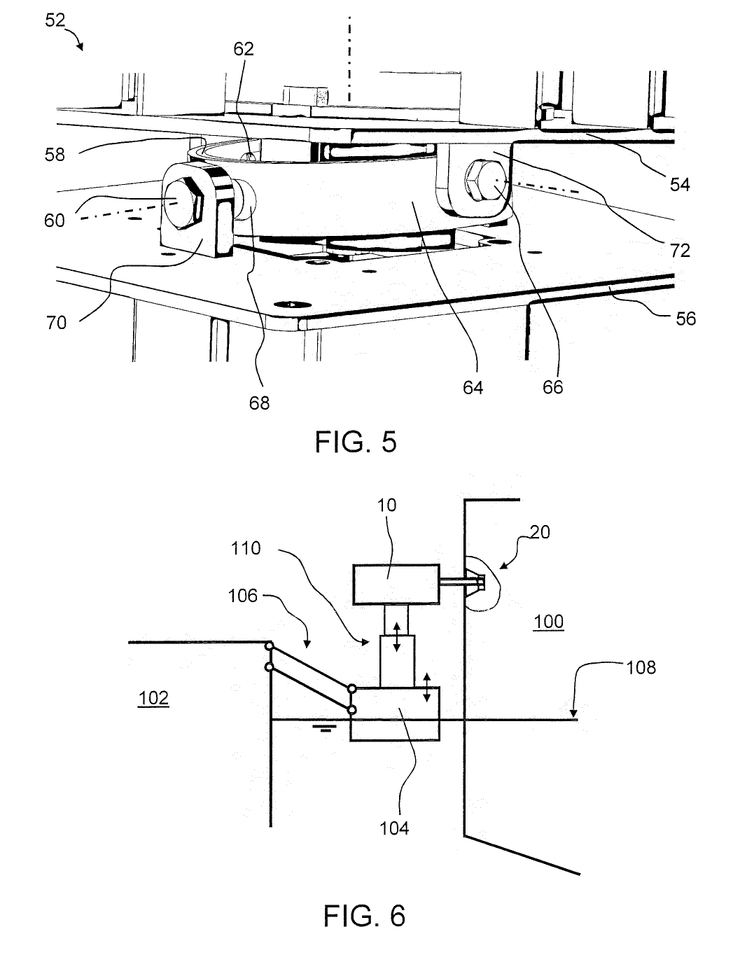

FIG. 5 shows a preferred embodiment of such an articulation 52, which is connected between an end plate 58 of the support beam 22 and a base plate 54 of the connector head 18. In this embodiment, the articulation 52 is a cardan joint 52, with three rotational degrees of freedom. This cardan joint 52 includes: an inner ring 58 with two inner ring pivots 60, which are spaced by 180°, and two inner ring slotted holes 62, which are circumferentially extending in the inner ring 58 and located at 90° from the two inner ring pivots 60; and an outer ring 64 with two outer ring pivots 66, which are spaced by 180°, and two outer ring slotted holes 68, which are circumferentially extending in the outer ring 64 and located at 90° from the two outer ring pivots 66. The outer ring 64 is mounted about the inner ring 58 so that both rings 58, 64 are coaxial with a common central axis and can rotate relative to one another. The inner ring pivots 60 are circumferentially guided in the outer ring slotted holes 68, and the outer ring pivots 66 are circumferentially guided in the inner ring slotted holes 62, whereby the cardan joint provides a rotational degree of freedom about said common central axis of both rings 58, 64. The maximum amplitude of this first rotational degree of freedom is defined by the length of the slotted holes 62, 68. With its outer ring pivots 66, the outer ring 64 is pivotably supported in brackets 70 of the end plate 58 of the support beam 22. This provides a second rotational degree of freedom. With its inner ring pivots 60, the inner ring 58 is pivotably supported in brackets 72 of the base plate 54 of the connector head 18. This provides a third rotational degree of freedom. It will be appreciated that this is a very rugged and inexpensive embodiment of the articulation 52, which provides full satisfaction in the present application, but that other embodiments of the articulation 52 are, of course, not excluded.

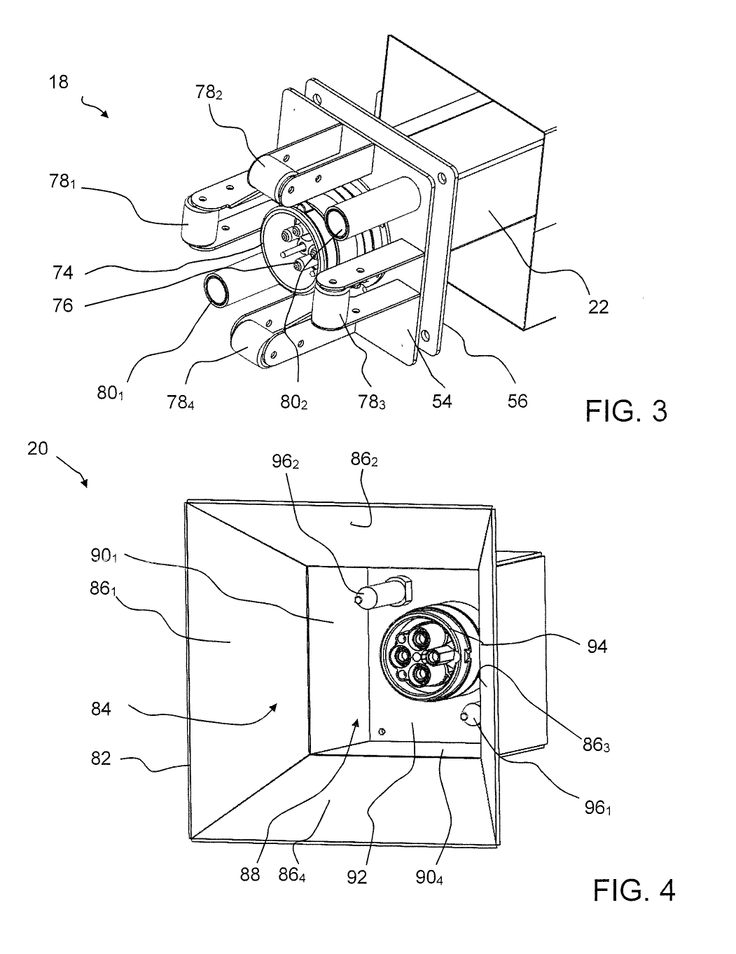

FIG. 3 shows a preferred embodiment of the connector head 18. On the front side of the base plate 54 is centrally arranged an electrical connector 74 with several contact elements 76. (The single electrical connector 74 shown in FIG. 3 can of course be replaced by an arrangement of several electrical connectors.) Four guide rolls 78ᵢ are symmetrically arranged around the connector 74, wherein the connector 74 is located centrally between the guide rolls 78ᵢ. (Each of the single guide rolls 78ᵢ can of course be replaced by an arrangement of multiple guide rolls.) Reference numbers 80_{1,2} identify two guide tubes, which are also symmetrically arranged with regard to the central connector 74. The function of the guide rolls 78ᵢ and the guide tubes 80ᵢ will be better understood after having read the description of FIG. 4.

Referring now to FIG. 4, which shows a preferred embodiment of the connection facility 20 arranged on the vehicle 12. This connection facility 20 includes an inlet funnel 82, which has the shape of a truncated pyramid with an inlet opening 84 and four inclined walls 86ᵢ (i=1 to 4). The four inclined walls 86ᵢ are pairwise substantially parallel to the to the reference axes X and Y. This inlet funnel 82 opens into a connector chamber 88 that is delimited by four lateral walls 90ᵢ and a base plate 92. The four lateral walls 90ᵢ are perpendicular to the base plate 92, and pairwise substantially perpendicular to the to the reference axes X and Y. (The base plate 92 is substantially perpendicular to the reference axis Z.) An electrical connector 94 protrudes from the base plate 92. This electrical connector 94 is mechanically and electrically complementary to the electrical connector 74 on the connector head 18, so that both connectors 74, 94 may be axially plugged together to create a temporary electrical connection.

Alternatively, the connection facility 20 may be equipped with an arrangement of electrical connectors, which are in this case mechanically and electrically complementary to an arrangement of electrical connectors supported by the connector head 18, so that the connectors of both arrangements may be axially plugged together to create a temporary electrical connection. It remains to be noted that the plug and socket connectors 74, 94 shown in FIGS. 3 and 4 may of course be replaced by any other type and number of electrical plug and socket connectors (i.e. by connectors that may be axially plugged together). Furthermore, they may also be replaced or supplemented by gas and/or fluid connectors that may be axially plugged together.

Reference numbers 96₁ and 96₂ identify two guide pins, which are symmetrically arranged with regard to the electrical connector 94 and complementary to the guide tubes 80₁ and 80₂ on the connector head 18. A sliding door, a hatch or a rolling shutter (not shown) can be provided to close the inlet funnel 82 or, alternatively, the front opening of the connector chamber 88, when the connection facility 20 is not used.

For establishing a connection to the vehicle 12, the connector head 18 must be brought by an axial forward movement of the support beam 22 in the direction of reference axis Z into the inlet opening 84 of the inlet funnel 82. If, when it penetrates into the inlet funnel 82, the connector head 18 is not perfectly aligned with the inlet funnel 82, a first of the guide roll 78ᵢ will contact one of the two inclined walls 86ᵢ that are parallel to reference axis X (respectively parallel to reference axis Y). When the connector head 18 penetrates deeper into the inlet funnel 82, the inclined wall 86ᵢ, which is in contact with this first guide roll 78ᵢ, will push the connector head 18 in the direction of reference axis Y (respectively of reference axis X) towards the centre of the inlet funnel 82, wherein the support beam 22 will follow this translation movement, due to its translational degree of freedom along reference axis Y (respectively along reference axis X), and hereby remain parallel to itself. As the connector head 18 further penetrates into the inlet funnel 82, a second of the guide rolls 78ᵢ will contact one of the two inclined walls 86ᵢ that are parallel to reference axis Y (respectively parallel to reference axis X). When the connector head 18 still further progresses into the inlet funnel 82, the inclined wall 86ᵢ, which is in contact with this second guide roll 78ᵢ, will push the connector head 18 in the direction of reference axis X (respectively of reference axis Y) towards the centre of the inlet funnel 82, wherein the support beam 22 will follow this translation movement, due to its translational degree of freedom along reference axis X (respectively along reference axis Y), and hereby remain parallel to itself. Thus the connector head 18 will be urged by the inclined walls 86ᵢ into the connector chamber 88. The dimensions of the cross-section of this connector chamber 88 are only slightly bigger than the dimensions of a rectangle exactly circumscribing the four guide rolls 78ᵢ in a plane perpendicular to the longitudinal axis 24 (or the reference axis Z), to ensure that the connector head 18 enters without problem into the connector chamber 88 but is nevertheless sufficiently centred therein to achieve a swift connection progress. In particular, the centring of the connector head 18 in the connector chamber 88 has to be sufficient to ensure that the guide pins 96₁, 96₂ penetrate with their cone-shaped ends into the guide tubes 80₁, 80₂, as the connector head 18 penetrates into the connector chamber 88. The cone-shaped ends of the guide pins 96₁, 96₂ will then provide a fine-tuning of the centring of the connector head 18 in the connector chamber 88, before the electrical connector 74 comes into mechanical contact with the electrical connector 94.

The three rotational degrees of freedom of the articulation 52 allow to compensate angular misalignments between the mating parts on the connector head 18 and in the connector chamber 88. Due to the three rotational degrees of freedom of the articulation 52, all initial angular misalignments between parts on the connector head 18 mating with parts in the connector chamber 88 will indeed disappear as soon as the guide pins 96₁, 96₂ sufficiently penetrate into the guide tubes 80₁, 80₂. Once, the guide pins 96₁, 96₂ have fully engaged the guide tubes 80₁, 80₂, the connector head 18 will be firmly blocked in the connector chamber 88 in the direction of reference axes X and Y. If the vehicle 12, for example in case of a ship, is subjected to small vertical and/or horizontal movements during its connection to the connection device 10, the support beam 22 can easily follow these movements, due its two translational degrees of freedom that are perpendicular to its longitudinal axis 24. Small angular movements of the vehicle 12 (i.e. a rolling, pitching and yawing), during its connection to the connection device 10, will be absorbed in the articulation 52, so that they will not affect the support beam 22.

It will be noted that instead of having two guide tubes 80ᵢ on the connector head 18 and two guide pins 96ᵢ in the connector chamber 88, one may also have two guide pins on the connector head 18 and two guide tubes in the connector chamber 88 or one guide tube and one guide pin on the connector head 18 and in the connector chamber 88. Furthermore, while the guide tubes 80ᵢ are the preferred solution for cooperating with the guide pins 96ᵢ, it is not excluded to replace such a guide tube 80ᵢ simply with a bore in a structural element of the connector head 18 or the connector chamber 88. Finally, instead of or in addition to having cone-shaped ends on the guide pins, one may also have guide tubes 80ᵢ with funnel-shaped inlet sections.

Referring again to FIG. 1, it will be noted that reference number 98 identifies a controller controlling the motor 46 and, more particularly, its direction of rotation, its speed and the motor torque (or motor force, in case of a linear motor) developed during forward and backward movements of the connector head 18. Forward movement (i.e. movement towards the vehicle) takes place at high speed with a low motor torque (force) limit. At the latest when the connector head 18 enters into the inlet funnel 82, speed is reduced, while the motor torque (force) limit remains low. Upon first engagement of the guide pins 96ᵢ, the motor torque (force) limit is increased. During connection, the motor 46 will continuously develop a motor torque (force) sufficient to prevent an unplugging when there is a small movement of the vehicle 12 in the direction of reference axis Z. For starting the backward movement, direction of rotation will be reversed and a high motor torque (force) limit will be set for unplugging, thereafter return movement will take place at high speed, with a low motor torque (force) limit. As soon as the connector head 18 comes close to the front opening 48, speed will be reduced, while the force limit remains low.

FIG. 6 is a diagrammatic representation of the connection device 10 of FIGS. 1 & 2 that is connected to a connection facility 20 in the hull of a ship 100, which is moored to a dock 102. In this embodiment, the connection device 10 is mounted on a floating body 104, which is connected by an articulated link mechanism 106 to the dock 102. This articulated link mechanism 106 is advantageously a parallelogram mechanism that is parallel to a vertical plane, so that the floating body 104 may follow the water level 108, wherein its upper surface remains always horizontal. Thus, when the water level 108 changes, both the connection device 10 and the ship 100 follow the water level 108, wherein the connection device 10 remains at the same height with regard to the connection facility 20 in the hull of the ship 100.

To be able to compensate for bigger differences of the height of the connection facility 20 with regard to water level 108 (for example, in case of different ship sizes or the same ship size with a different ballasted condition), the connection device 10 may be supported on the floating body 104 by means of an auxiliary support structure 110 that is adjustable in height. Alternatively or additionally, the floating body 104 may also be equipped with ballast tanks (not shown) that can be filled with more or less water and pumped empty to adjust the height of the connection device 10 above water level 108. Furthermore, instead of being fixed to the dock 102, the articulated link mechanism 106 can of course be fixed to a vehicle (not shown), in particular a rail-guided vehicle, that moves along the dock 102. Finally, if the ship, in particular a ferry, is connected to the dock 102 by means of a ramp with a king-pin, or similar, for holding the ferry in position, the connection device 10 may of course be directly supported on this ramp.

### REFERENCE SIGNS LIST

| | |
|---|---|
| 10 | connection device |
| 12 | vehicle or outer vehicle wall |
| 14 | energy or fluid distribution |
| | system |
| 16 | main support structure (outer |
| | casing) |
| 18 | connector head |
| 20 | connection facility on 12 |
| 22 | support beam |
| 24 | longitudinal axis of 22 |
| 26 | support mechanism (three- |
| | dimensional parallelogram |
| | mechanism) |
| 28 | fixed rear end link or frame link |
| 30 | movable front-end link, front |
| | plate |
| 32ᵢ | parallel connection links |
| 34ᵢ | cardan joints |
| 36ᵢ | suspension springs |
| 37 | supporting rod |
| 38 | elongate guide structure (guide |
| | channel) |
| 40 | two pairs of wheels |
| 42 | two pairs of rails |
| 44 | reversible linear drive |
| 46 | reversible motor |
| 48 | front opening in 16 |
| 50 | frontal cavity |
| 52 | articulation |
| 54 | base plate |
| 56 | end plate |
| 58 | inner ring |
| 60 | inner ring pivots |
| 62 | inner ring slotted holes |
| 64 | outer ring |
| 66 | outer ring pivots |
| 68 | outer ring slotted holes |
| 70 | brackets |
| 72 | brackets |
| 74 | electrical connector |
| 76 | contact elements on 74 |
| 78ᵢ | guide rolls |
| 80_{1,2} | guide tubes |
| 82 | inlet funnel |
| 84 | inlet opening of 82 |
| 86ᵢ | four inclined walls |
| 88 | connector chamber |
| 90ᵢ | four lateral walls of 86 |
| 92 | base plate of 86 |
| 94 | electrical connector |
| 96_{1,2} | guide pins |
| 100 | ship |
| 102 | dock |
| 104 | floating body |
| 106 | articulated link mechanism |
| 108 | water level |
| 110 | auxiliary support structure |

1. A connection device for establishing a connection between a vehicle and a fluid or energy distribution system, said connection device comprising:
a main support structure;
a connector head, for releasably connecting to a connection facility on said vehicle;
a support beam having a longitudinal axis, a front-end supporting said connector head and a rear end;
a support mechanism supporting said rear end in said main support structure, so that said support beam is movable along its longitudinal axis and has two translational degrees of freedom that are perpendicular to its longitudinal axis; and
an articulation with three rotational degrees of freedom connected between said front-end of said support beam and said connector head.

2. The device as claimed in claim 1, wherein said support mechanism comprises a three-dimensional parallelogram mechanism having a rear end link supported by said main support structure and a movable front-end link supporting said support beam, wherein said support beam remains parallel to itself when said front-end link is moved out of a home position.

3. The device as claimed in claim 2, wherein:
said home position is defined by springs and by gravity forces.

4. The device as claimed in claim 2, wherein said front-end link of said three-dimensional parallelogram mechanism supports a guide channel in a cantilevered way, said rear end of said support beam being guided by said guide channel so that said support beam is movable in a guided way along its longitudinal axis.

5. The device as claimed in claim 4, wherein:
said rear end of said support beam includes wheels that are guided in rails of said guide channel.

6. The device as claimed in claim 4, further comprising:
a reversible drive for driving said support beam in a forward movement and a backward movement along said guide channel.

7. The device as claimed in claim 6, wherein:
said drive is a linear drive, preferably a chain drive, more preferably an endless chain drive with a servo or stepper motor.

8. The device as claimed in claim 1, wherein said articulation connected between said front-end of said support beam and said connector head is a cardan joint including:
an inner ring with two inner ring pivots, which are spaced by 180°, and two inner ring slotted holes, which are circumferentially extending and located at 90° from the two inner ring pivots;
an outer ring with two outer ring pivots, which are spaced by 180°, and two outer ring slotted holes, which are circumferentially extending and located at 90° from the two outer ring pivots; wherein:
said outer ring is mounted about said inner ring so that both rings are coaxial with a common central axis and can rotate relative to one another, and said inner ring pivots are circumferentially guided in said outer ring slotted holes, and said outer ring pivots are circumferentially guided in said inner ring slotted holes; wherein;
said outer ring and said inner ring cooperate provide a first rotational degree of freedom;
said outer ring pivots and inner ring pivots cooperate with said front-end of said support beam and said connector head, to define two further rotational degrees of freedom.

9. The device as claimed in claim 1, wherein each of said three rotational degrees of freedom of said articulation connected between said front-end of said support beam and said connector head, is mechanically limited to less than +/−10°.

10. The device as claimed in claim 1, wherein the vehicle is a ship, said device further comprising:
a floating body supporting said main support structure.

11. The device as claimed in claim 1, wherein said connector head comprises:
a front side; and
a connector or a connector arrangement arranged on said front side.

12. The device as claimed in claim 11, wherein said connector head further comprises:
at least four guide rolls or four guide roll arrangements arranged symmetrically around said connector or connector arrangement.

13. The device as claimed in claim 11 or 12, wherein said connector head further comprises:
two guide pins or two guide tubes or a guide pin and a guide tube arranged around said connector or said connector arrangement.

14. A connection system for establishing a connection between a vehicle and a fluid or energy distribution system, said connection system comprising:
a connection device as claimed in claim 1; and
a funnel-shaped connection facility on said vehicle;
wherein for establishing a connection between said vehicle and said fluid or energy distribution system, said connection head is introduced into said funnel-shaped connection facility.

15. The connection system as claimed in claim 14,
wherein said connector head comprises at least four guide rolls or four guide roll arrangements arranged symmetrically around said connector or connector arrangement; and
wherein:
said funnel-shaped connection facility has an inlet section that has the shape of a truncated pyramid with four surfaces, each of these surfaces being capable of cooperating with one of said four guide rolls or one of said four guide roll arrangements for centring said connection head in said funnel-shaped connection facility.

16. The connection system as claimed in claim 14, wherein said connector head comprises two guide pins or two guide tubes or a guide pin and a guide tube arranged around said connector or said connector arrangement, and wherein
said funnel-shaped connection facility has at least one guide pin that cooperates with a guide tube on said connector head and/or at least one guide tube that cooperates with a guide pin on said connector head.

17. A connection device for establishing a connection between a vehicle and a fluid or energy distribution system, said connection device comprising:
a main support structure;
a connector head, for releasably connecting to a connection facility on said vehicle;
a support beam having a longitudinal axis, a front-end supporting said connector head and a rear end; and
a support mechanism supporting said rear end in said main support structure, so that said support beam is movable along its longitudinal axis and has two translational degrees of freedom that are perpendicular to its longitudinal axis;
an articulation with three rotational degrees of freedom connected between said front-end of said support beam and said connector head;
wherein said support mechanism comprises a three-dimensional parallelogram mechanism having a rear end link supported by said main support structure and a movable front-end link supporting said support beam, wherein said support beam remains parallel to itself when said front-end link is moved out of a home position,
wherein said front-end link of said three-dimensional parallelogram mechanism supports a guide channel in a cantilevered way, said rear end of said support beam being guided by said guide channel so that said support beam is movable in a guided way along its longitudinal axis, and wherein the connection device comprises a reversible drive for driving said support beam in a forward movement and a backward movement along said guide channel.
